(19) United States
(12) Patent Application Publication
(10) Pub. No.: US 2024/0340791 A1
(43) Pub. Date: Oct. 10, 2024

(54) METHOD FOR REQUESTING MONITORING STATE, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 18/747,277

(22) Filed: Jun. 18, 2024

Related U.S. Application Data
(63) Continuation of application No. PCT/CN2021/140442, filed on Dec. 22, 2021.

(51) Int. Cl. H04W 52/02

(52) U.S. Cl. CPC H04W 52/0225

(57) ABSTRACT

A method for requesting a monitoring state, a terminal device, and a network device are provided. The method for requesting the monitoring state includes the following. A terminal device transmits a first request message to a network device, where the first request message is used for requesting to enter an ultra-lower power receiver state. The terminal device receives a first response message from the network device, where the first response message indicates the terminal device to enter the ultra-lower power receiver state.

### CROSS REFERENCE TO RELATED APPLICATION(S)

This application is a continuation of International Application No. PCT/CN2021/140442, filed Dec. 22, 2021, the entire disclosure of which is incorporated herein by reference.

### TECHNICAL FIELD

This disclosure relates to the field of communication technology, and in particular, to a method for requesting a monitoring state, a terminal device, and a network device.

### BACKGROUND

In a new radio (NR) system, a network can configure a discontinuous reception (DRX) mechanism for a terminal, so as to achieve power saving at the terminal. A configuration parameter for DRX includes drx-onDurationTimer. In NR R16, if a physical downlink control channel (PDCCH)-based wake-up signal (PDCCH-WUS) is detected by the terminal and the WUS indicates the terminal to start drx-onDurationTimer, the terminal starts the drx-onDurationTimer.

The terminal has two available receiver states, including an ultra-lower power receiver state and a main receiver state. Only when receiving an ultra-lower power WUS (LP-WUS) does the terminal start a main receiver to monitor a downlink signal, thereby achieving energy saving. Compared with a WUS mechanism, the LP-WUS is more energy-saving. However, when the terminal enters the ultra-lower power receiver state is a problem to be solved.

### SUMMARY

In a first aspect, a method for requesting a monitoring state is provided. The method is applicable to a terminal device and includes the following. A first request message is transmitted to a network device, where the first request message is used for requesting to enter an ultra-lower power receiver state. A first response message is received from the network device, where the first response message indicates the terminal device to enter the ultra-lower power receiver state.

In a second aspect, a terminal device is provided. The terminal device includes: a transceiver, a memory configured to store computer programs, and a processor configured to execute the computer programs stored in the memory to cause the transceiver to: transmit a first request message to a network device and receive a first response message from the network device. The first request message is used for requesting to enter an ultra-lower power receiver state. The first response message indicates the terminal device to enter the ultra-lower power receiver state.

In a third aspect, a network device is provided. The network device includes a transceiver, a memory configured to store computer programs, and a processor configured to execute the computer programs stored in the memory to cause the transceiver to: receive a first request message from a terminal device and transmit a first response message to the terminal device. The first request message is used for requesting to enter an ultra-lower power receiver state. The first response message indicates the terminal device to enter the ultra-lower power receiver state.

### BRIEF DESCRIPTION OF THE DRAWINGS

FIG. 1 is a schematic diagram of a discontinuous reception (DRX) cycle.

FIG. 2 is a schematic diagram illustrating switching between two receiver states by a terminal.

FIG. 3 is a schematic diagram of a method for requesting a monitoring state provided in embodiments of the disclosure.

FIG. 4 is a schematic diagram of another method for requesting a monitoring state provided in embodiments of the disclosure.

FIG. 5 is a schematic diagram of another method for requesting a monitoring state provided in embodiments of the disclosure.

FIG. 6 is a schematic diagram of another method for requesting a monitoring state provided in embodiments of the disclosure.

FIG. 7 is a schematic diagram of a communication apparatus provided in embodiments of the disclosure.

FIG. 8 is a schematic diagram of a terminal device provided in embodiments of the disclosure.

FIG. 9 is a schematic diagram of another communication apparatus provided in embodiments of the disclosure.

FIG. 10 is a schematic diagram of a network device provided in embodiments of the disclosure.

### DETAILED DESCRIPTION

The following will describe technical solutions of the disclosure with reference to the accompanying drawings.

Some terms in embodiments of the disclosure will be explained below to facilitate understanding by those skilled in the art.

In embodiments of the disclosure, “at least one” refers to one or more, and “a plurality of” or “multiple” refers to two or more. “And/or” describes an association relationship between associated objects, which means that there may be three relationships. For example, A and/or B may mean A alone, both A and B exist, and B alone, where A and B each may be singular or plural. The character “/” herein generally indicates that the associated objects are in an “or” relationship. “At least one (item) of the following” as well as similar expressions thereof refers to any combination of these items, including any combination of a singular item (one) or a plural item (one). For example, at least one (item) of a, b, or c may mean: a, b, c, a-b, a-c, b-c, or a-b-c, where a, b, and c each may be one or multiple.

In addition, unless stated otherwise, the ordinal numbers such as “first” and “second” mentioned in embodiments of the disclosure are used for distinguishing multiple objects, rather than defining the order, timing, priority, or importance of the multiple objects. For example, “first information” and “second information” are only intended for differentiating different information, rather than indicating differences between the two types of information in terms of content, priority, sending order, importance, or the like.

For better understanding of the disclosure, concepts related to the disclosure will be firstly explained.

5th generation mobile communication technology (5G) new radio (NR) discontinuous reception (DRX): in 5G NR, a network can configure a DRX mechanism for a user equipment (UE), so that the UE can monitor a physical downlink control channel (PDCCH) discontinuously, thereby achieving power saving at the terminal. Each medium access control (MAC) entity has a DRX configuration, and configuration parameters for the DRX include the following.

1. Drx-onDurationTimer, which indicates a duration for which the terminal is awake at the beginning of a DRX cycle.

2. Drx-SlotOffset, which indicates a delay in starting the drx-onDurationTimer by the terminal.

3. Drx-InactivityTimer, which indicates a duration for which the terminal continues to monitor a PDCCH after receiving the PDCCH indicating an initial uplink transmission or an initial downlink transmission.

4. Drx-RetransmissionTimerDL, which indicates a maximum duration for which the terminal monitors a PDCCH indicating downlink retransmission scheduling. Each downlink hybrid automatic repeat request (HARQ) process except for a broadcast HARQ process corresponds to one drx-RetransmissionTimerDL.

5. Drx-RetransmissionTimerUL, which indicates a maximum duration for which the terminal monitors a PDCCH indicating uplink retransmission scheduling. Each uplink HARQ process corresponds to one drx-RetransmissionTimerUL.

6. Drx-LongCycleStartOffset, which is used for configuring a long DRX cycle and a subframe offset of the start of the long DRX cycle and a short DRX cycle.

7. Drx-ShortCycle, which indicates the short DRX cycle, which is an optional configuration.

8. Drx-ShortCycletimer, which indicates a duration for which the terminal is in the short DRX cycle (and has not received any PDCCH), which is an optional configuration.

9. Drx-HARQ-RTT-TimerDL, which indicates a minimum waiting time before a PDCCH indicating downlink scheduling is expected by the terminal to receive. Each downlink HARQ process except for the broadcast HARQ process corresponds to one drx-HARQ-RTT-TimerDL.

10. Drx-HARQ-RTT-TimerUL, which indicates a minimum waiting time before a PDCCH indicating uplink scheduling is expected by the terminal to receive. Each uplink HARQ process corresponds to one drx-HARQ-RTT-TimerUL.

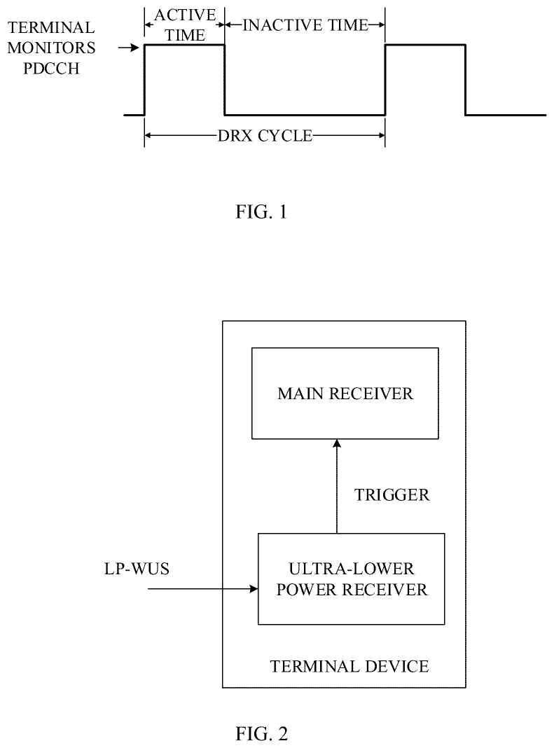

Reference is made to FIG. 1, where FIG. 1 is a schematic diagram of a DRX cycle. As illustrated in FIG. 1, the DRX cycle includes an active time and an inactive time. In the active time (also referred to as on duration), a ULE monitors and receives a PDCCH. In the inactive time, the UE does not receive the PDCCH, so as to reduce power consumption.

If a terminal is configured with DRX, the terminal needs to monitor the PDCCH in the DRX active time. The terminal may be in the DRX active time in the following cases.

1. Any one of five timers, namely, drx-onDurationTimer, drx-InactivityTimer, drx-RetransmissionTimerDL, drx-RetransmissionTimerUL, and ra-ContentionResolutionTimer is running. The ra-ContentionResolutionTimer is started after message 3 (Msg3) is transmitted in a random access procedure.

2. A scheduling request (SR) is transmitted on a physical uplink control channel (PUCCH) and is in a pending state.

3. In a contention based random access (CBRA) procedure, after successfully receiving a random access response, the terminal has not received an initial transmission indicated by a PDCCH scrambled by a cell radio network temporary identifier (C-RNTI).

The terminal determines, according to whether the terminal is currently in a short DRX cycle or in a long DRX cycle, a time to start the drx-onDurationTimer. The specific procedure includes the following.

1. If the terminal is currently in the short DRX cycle, and a current subframe satisfies [(SFN×10)+subframe number] modulo (drx-ShortCycle)=(drx-StartOffset) modulo (drx-ShortCycle), where SFN refers to a system frame number, subframe number refers to a subframe number, modulo represents a modulo operation, drx-ShortCycle represents a short DRX cycle, and drx-StartOffset represents a start offset; or

2. If the terminal is currently in the long DRX cycle, and a current subframe satisfies [(SFN×10)+subframe number] modulo (drx-LongCycle)=drx-StartOffset, where drx-LongCycle represents a long DRX cycle:

3. Start the drx-onDurationTimer after drx-SlotOffset slots from the beginning of the current subframe, where the drx-SlotOffset indicates a delay in starting the drx-onDurationTimer by the terminal.

A condition to be satisfied for the terminal to start or restart the drx-InactivityTimer is as follows. The terminal starts or restarts the drx-InactivityTimer if a PDCCH indicating an initial downlink or uplink transmission is received by the terminal.

A condition to be satisfied for the terminal to start and stop the drx-RetransmissionTimerDL is as follows. When a PDCCH indicating a downlink transmission is received by the terminal, or when an MAC protocol data unit (PDU) is received by the terminal on a configured downlink-grant-resource, the terminal stops drx-RetransmissionTimerDL corresponding to an HARQ process. The terminal starts drx-HARQ-RTT-TimerDL corresponding to the HARQ process after completing transmission of an HARQ process feedback for this downlink transmission. If a timer drx-HARQ-RTT-TimerDL corresponding to a certain HARQ of the terminal expires, and the decoding of downlink data transmitted by this HARQ process fails, the terminal starts the drx-RetransmissionTimerDL corresponding to this HARQ process.

A condition to be satisfied for the terminal to start and stop the drx-RetransmissionTimerUL is as follows. When a PDCCH indicating an uplink transmission is received by the terminal, or when an MAC PDU is transmitted by the terminal on a configured uplink-grant-resource, the terminal stops drx-RetransmissionTimerUL corresponding to an HARQ process. The terminal starts drx-HARQ-RTT-TimerUL corresponding to the HARQ process after completing a first repetition for a physical uplink shared channel (PUSCH). If a timer drx-HARQ-RTT-TimerUL corresponding to a certain HARQ of the terminal expires, the terminal starts the drx-RetransmissionTimerUL corresponding to this HARQ process.

The long DRX cycle is a default configuration, and the short DRX cycle is an optional configuration. For a terminal configured with the short DRX cycle, the switch between the long DRX cycle and the short DRX cycle is as follows.

1. When any one of the following conditions is satisfied, the terminal uses the short DRX cycle.

a. The drx-InactivityTimer expires.

b. A DRX command MAC control element (CE) is received by the terminal.

2. When any one of the following conditions is satisfied, the terminal uses the long DRX cycle.

a. The drx-ShortCycleTimer expires.

b. A long DRX command MAC CE is received by the terminal.

Wake-up signal (WUS): a power saving signal, i.e., a WUS, is introduced in NR R16. Before starting the drx-onDurationTimer, the terminal blindly detects a PDCCH-based WUS (PDCCH-WUS). If the PDCCH-WUS is detected and the WUS indicates the terminal to start the drx-onDurationTimer, the terminal starts the drx-onDurationTimer. In other cases, the terminal does not start the drx-onDurationTimer.

Reference is made to FIG. 2, where FIG. 2 is a schematic diagram illustrating switching between two receiver states by a terminal. As illustrated in FIG. 2, the terminal has two available receiver states, including an ultra-lower power receiver state and a main receiver state. Only when receiving an ultra-lower power WUS (LP-WUS) does the terminal start a main receiver to monitor a downlink signal, thereby achieving energy saving. Compared with a WUS mechanism, the LP-WUS is more energy-saving. However, when the terminal enters the ultra-lower power receiver state is a problem to be solved.

The related art of the disclosure has been described above, and technical features of embodiments of the disclosure will be described below.

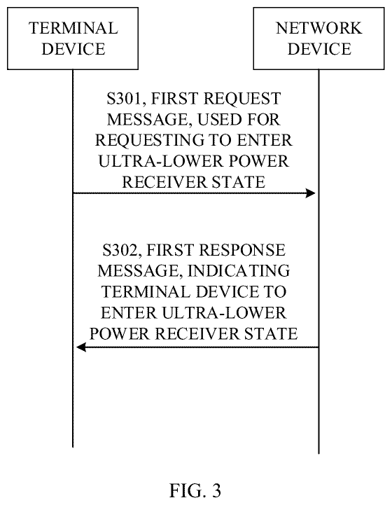

Reference is made to FIG. 3, where FIG. 3 is a schematic diagram of a method for requesting a monitoring state provided in embodiments of the disclosure. As illustrated in FIG. 3, the method for requesting the monitoring state includes the following.

S301, a terminal device transmits a first request message to a network device. The first request message is used for requesting to enter an ultra-lower power receiver state.

Specifically, the terminal device expects to enter the ultra-lower power receiver state according to a state of the terminal device (for example, when a battery level is low). In this case, the terminal device transmits the first request message to the network device to request to enter the ultra-lower power receiver state.

Optionally, the terminal device is in a radio resource control (RRC) connected state. Before transmitting the first request message to the network device, the terminal device receives configuration information from the network device. The configuration information indicates that the network device supports an LP-WUS and/or configures the terminal device to transmit the first request message to the network device.

Specifically, the terminal device in the RRC connected state receives the configuration information from the network device. The configuration information indicates that the network device supports the LP-WUS and/or configures the terminal device to transmit the first request message to the network device. In a possible implementation, the configuration information is configured through an RRC dedicated signaling. For example, the RRC dedicated signaling may be an RRC reconfiguration message.

Optionally, the first request message contains assistance information.

Specifically, the terminal device transmits the assistance information to the network device to request to enter the ultra-lower power receiver state. The assistance information may be transmitted in UEAssistanceInformation.

Optionally, the first request message further indicates a duration T1 for which the terminal device requests to enter the ultra-lower power receiver state.

Optionally, the terminal device is in an RRC idle state or in an RRC inactive state. Before transmitting the first request message to the network device, the terminal device receives a system information broadcast (SIB). The SIB indicates that the network device supports an LP-WUS and/or the network device allows the terminal device to transmit the first request message.

Optionally, the first request message is transmitted in Msg3, message A (MsgA), or a configured grant (CG).

In a possible implementation, the terminal device in the RRC idle state or in the RRC inactive state transmits the first request message to the network device. The first request message is carried in Msg3 in a random access procedure. A new RRC message such as RRCLowerPowerRequest may be introduced.

In a possible implementation, the terminal device in the RRC idle state or in the RRC inactive state transmits the first request message to the network device. The first request message is carried in MsgA in a random access procedure. A new RRC message such as RRCLowerPowerRequest may be introduced.

In a possible implementation, the terminal device in the RRC idle state or in the RRC inactive state transmits the first request message to the network device. The first request message is transmitted in a CG in the idle state or a CG in the inactive state.

Optionally, the first request message is transmitted through an MAC CE or an RRC dedicated signaling.

Specifically, the first request message is transmitted through the RRC dedicated signaling. An existing RRC message such as RRCSetupRequest, RRCReestablishmentRequest, RRCResumeRequest, and RRCResumeRequest1 may be extended. Information for the request by the terminal device to enter the ultra-lower power receiver state may be added into the existing RRC message. Further, in a possible implementation, the duration T1 for which the terminal device requests to enter the ultra-lower power receiver state may also be added into the existing RRC message.

S302, the terminal device receives a first response message from the network device. The first response message indicates the terminal device to enter the ultra-lower power receiver state.

Optionally, the first response message further indicates a duration T2 for which the terminal device enters the ultra-lower power receiver state.

Specifically, the first request message further indicates the duration T1 for which the terminal device requests to enter the ultra-lower power receiver state. The network device determines T2 according to T1. In a possible implementation, T2 is less than or equal to T1.

Optionally, after receiving the first response message from the network device, the terminal device turns off a main receiver and enters the ultra-lower power receiver state. Upon elapse of the duration T2 for entering the ultra-lower power receiver state, the terminal device turns on the main receiver and exits the ultra-lower power receiver state.

Specifically, the first response message further indicates the duration T2 for which the terminal device enters the ultra-lower power receiver state. In other words, the network device indicates that a duration for which the terminal device enters the ultra-lower power receiver state is T2. After receiving the first response message from the network device, the terminal device enters the ultra-lower power receiver state. Upon elapse of the duration T2, the terminal device exits the ultra-lower power receiver state.

Optionally, after receiving the first response message from the network device, the terminal device turns off a main receiver and enters the ultra-lower power receiver state. When receiving the LP-WUS from the network device or transmitting uplink data, the terminal device turns on the main receiver and exits the ultra-lower power receiver state.

Specifically, the network device does not indicate a duration for which the terminal device enters the ultra-lower power receiver state. After receiving the first response message from the network device, the terminal device enters the ultra-lower power receiver state. The terminal device is always in the ultra-lower power receiver state. The terminal device will not exit the ultra-lower power receiver state until receiving the LP-WUS from the network device or having uplink data to be transmitted.

Optionally, when the first request message is transmitted in the Msg3, the first response message is received in message 4 (Msg4). When the first request message is transmitted in the MsgA, the first response message is received in message B (MsgB).

Optionally, after receiving the first response message from the network device, the terminal device turns off a main receiver and enters the ultra-lower power receiver state.

In a possible implementation, the terminal device in the RRC idle state or in the RRC inactive state transmits the first request message to the network device. The first request message is carried in Msg3 in a random access procedure. The network device transmits the first response message in Msg4. A new RRC message such as RRCLowerPowerResponse may be introduced. Further, optionally, the duration T2 for which the network device indicates the terminal device to enter the ultra-lower power receiver state may also be added into the first response message. After receiving the first response message, the terminal turns off the main receiver and enters the ultra-lower power receiver state. After the terminal device transmits the first request message to the network device, the network device may also transmit a reject message. Anew RRC message such as RRCLowerPowerReject may be introduced. In this case, the terminal device continues to use a main-receiver monitoring state.

In a possible implementation, the terminal device in the RRC idle state or in the RRC inactive state transmits the first request message to the network device. The first request message is carried in MsgA in a random access procedure. The network device transmits the first response message in MsgB. A new RRC message such as RRCLowerPowerResponse may be introduced. Further, optionally, the duration T2 for which the network device indicates the terminal device to enter the ultra-lower power receiver state may also be added into the first response message. After receiving the first response message, the terminal turns off the main receiver and enters the ultra-lower power receiver state. After the terminal device transmits the first request message to the network device, the network device may also transmit a reject message. Anew RRC message such as RRCLowerPowerReject may be introduced. In this case, the terminal device continues to use a main-receiver monitoring state.

Optionally, after establishment of RRC connection, the terminal device in the RRC idle state or in the RRC inactive state may transmit the first request message to the network device.

In a possible implementation, the terminal device transmits the first request message to the network device to request to enter the ultra-lower power receiver state. If the terminal device receives the first response message from the network device and the first response message indicates the terminal device to enter the ultra-lower power receiver state, the terminal device enters the ultra-lower power receiver state. If the terminal device fails to receive the first response message from the network device, the terminal device does not enter the ultra-lower power receiver state.

In the above method, the terminal device transmits the first request message to the network device to request to enter the ultra-lower power receiver state. If the terminal device receives the first response message from the network device and the first response message indicates the terminal device to enter the ultra-lower power receiver state, the terminal device enters the ultra-lower power receiver state. In this way, by means of introducing a request message from the terminal device, the terminal device in need of energy saving can transmit a request to a network, so as to assist the network in determining that the terminal device is to enter the ultra-lower power receiver state. Finally, energy saving at the terminal device can be achieved, and the problem of when the terminal device enters the ultra-lower power receiver state can be solved.

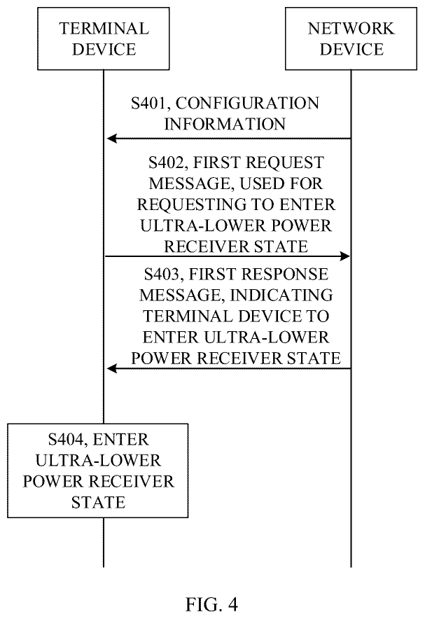

Reference is made to FIG. 4, where FIG. 4 is a schematic diagram of another method for requesting a monitoring state provided in embodiments of the disclosure. In the method for requesting the monitoring state, a terminal device is in an RRC connected state. As illustrated in FIG. 4, the method for requesting the monitoring state includes the following.

S401, the terminal device receives configuration information from a network device.

Specifically, the terminal device is in the RRC connected state. The terminal device receives the configuration information from the network device. The configuration information indicates that the network device supports an LP-WUS and/or configures the terminal device to transmit a first request message to the network device.

In a possible implementation, the configuration information is configured through an RRC dedicated signaling. For example, the RRC dedicated signaling may be an RRC reconfiguration message.

S402, the terminal device transmits a first request message to the network device. The first request message is used for requesting to enter an ultra-lower power receiver state.

Specifically, the terminal device expects to enter the ultra-lower power receiver state according to a state of the terminal device (for example, when a battery level is low). In this case, the terminal device transmits the first request message to the network device to request to enter the ultra-lower power receiver state.

Optionally, the first request message contains assistance information.

Specifically, the terminal device transmits the assistance information to the network device to request to enter the ultra-lower power receiver state. The assistance information may be transmitted in UEAssistanceInformation.

Optionally, the first request message further indicates a duration T 1 for which the terminal device requests to enter the ultra-lower power receiver state.

S403, the terminal device receives a first response message from the network device. The first response message indicates the terminal device to enter the ultra-lower power receiver state.

Optionally, the first response message further indicates a duration T2 for which the terminal device enters the ultra-lower power receiver state.

Specifically, the first request message further indicates the duration T1 for which the terminal device requests to enter the ultra-lower power receiver state. The network device determines T2 according to T1. In a possible implementation, T2 is less than or equal to T1.

S404, the terminal device enters the ultra-lower power receiver state.

Optionally, after receiving the first response message from the network device, the terminal device turns off a main receiver and enters the ultra-lower power receiver state. Upon elapse of the duration T2 for entering the ultra-lower power receiver state, the terminal device turns on the main receiver and exits the ultra-lower power receiver state.

Specifically, the first response message further indicates the duration T2 for which the terminal device enters the ultra-lower power receiver state. In other words, the network device indicates that a duration for which the terminal device enters the ultra-lower power receiver state is T2. After receiving the first response message from the network device, the terminal device enters the ultra-lower power receiver state. Upon elapse of the duration T2, the terminal device exits the ultra-lower power receiver state.

Optionally, after receiving the first response message from the network device, the terminal device turns off a main receiver and enters the ultra-lower power receiver state. When receiving the LP-WUS from the network device or transmitting uplink data, the terminal device turns on the main receiver and exits the ultra-lower power receiver state.

Specifically, the network device does not indicate a duration for which the terminal device enters the ultra-lower power receiver state. After receiving the first response message from the network device, the terminal device enters the ultra-lower power receiver state. The terminal device is always in the ultra-lower power receiver state. The terminal device will not exit the ultra-lower power receiver state until receiving the LP-WUS from the network device or having uplink data to be transmitted.

In a possible implementation, the terminal device transmits the first request message to the network device to request to enter the ultra-lower power receiver state. If the terminal device receives the first response message from the network device and the first response message indicates the terminal device to enter the ultra-lower power receiver state, the terminal device enters the ultra-lower power receiver state. If the terminal device fails to receive the first response message from the network device, the terminal device does not enter the ultra-lower power receiver state.

In the above method, by means of introducing a request message from the terminal device, the terminal device in the RRC connected state in need of energy saving can transmit a request to a network, so as to assist the network in determining that the terminal device is to enter the ultra-lower power receiver state. Finally, energy saving at the terminal device can be achieved, and the problem of when the terminal device enters the ultra-lower power receiver state can be solved.

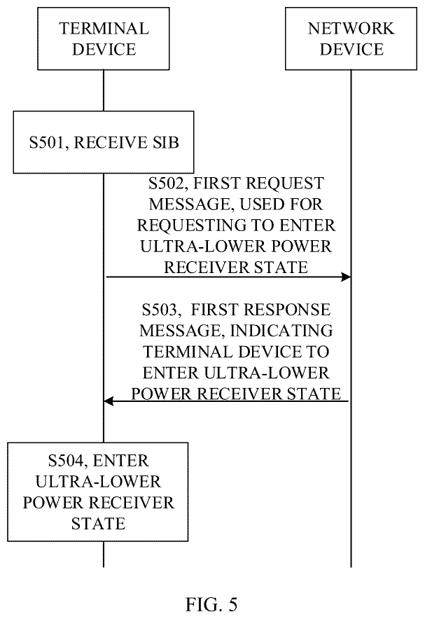

Reference is made to FIG. 5, where FIG. 5 is a schematic diagram of another method for requesting a monitoring state provided in embodiments of the disclosure. In the method for requesting the monitoring state, a terminal device is in an RRC idle state or in an RRC inactive state. As illustrated in FIG. 5, the method for requesting the monitoring state includes the following.

S501, the terminal device receives an SIB.

Specifically, the terminal device is in the RRC idle state or in the RRC inactive state. The terminal device receives the SIB. The SIB indicates that the network device supports an LP-WUS and/or the network device allows the terminal device to transmit a first request message.

S502, the terminal device transmits a first request message to the network device. The first request message is used for requesting to enter an ultra-lower power receiver state.

Specifically, the terminal device expects to enter the ultra-lower power receiver state according to a state of the terminal device (for example, when a battery level is low). In this case, the terminal device transmits the first request message to the network device to request to enter the ultra-lower power receiver state.

Optionally, the first request message is transmitted in Msg3, MsgA, or a CG.

In a possible implementation, the terminal device in the RRC idle state or in the RRC inactive state transmits the first request message to the network device. The first request message is carried in Msg3 in a random access procedure. A new RRC message such as RRCLowerPowerRequest may be introduced.

In a possible implementation, the terminal device in the RRC idle state or in the RRC inactive state transmits the first request message to the network device. The first request message is carried in MsgA in a random access procedure. A new RRC message such as RRCLowerPowerRequest may be introduced.

In a possible implementation, the terminal device in the RRC idle state or in the RRC inactive state transmits the first request message to the network device. The first request message is transmitted in a CG in the idle state or a CG in the inactive state.

Optionally, the first request message is transmitted through an MAC CE or an RRC dedicated signaling.

Specifically, the first request message is transmitted through the RRC dedicated signaling. An existing RRC message such as RRCSetupRequest, RRCReestablishmentRequest, RRCResumeRequest, and RRCResumeRequest1 may be extended. Information for the request by the terminal device to enter the ultra-lower power receiver state may be added into the existing RRC message. Further, in a possible implementation, the duration T1 for which the terminal device requests to enter the ultra-lower power receiver state may also be added into the existing RRC message.

S503, the terminal device receives a first response message from the network device. The first response message indicates the terminal device to enter the ultra-lower power receiver state.

Optionally, when the first request message is transmitted in the Msg3, the first response message is received in Msg4. When the first request message is transmitted in the MsgA, the first response message is received in MsgB.

In a possible implementation, the terminal device in the RRC idle state or in the RRC inactive state transmits the first request message to the network device. The first request message is carried in Msg3 in a random access procedure. The network device transmits the first response message in Msg4. A new RRC message such as RRCLowerPowerResponse may be introduced. Further, optionally, the duration T2 for which the network device indicates the terminal device to enter the ultra-lower power receiver state may also be added into the first response message.

In a possible implementation, the terminal device in the RRC idle state or in the RRC inactive state transmits the first request message to the network device. The first request message is carried in MsgA in a random access procedure. The network device transmits the first response message in MsgB. A new RRC message such as RRCLowerPowerResponse may be introduced. Further, optionally, the duration T2 for which the network device indicates the terminal device to enter the ultra-lower power receiver state may also be added into the first response message.

S504, the terminal device enters the ultra-lower power receiver state.

Specifically, after receiving the first response message, the terminal turns off the main receiver and enters the ultra-lower power receiver state. After the terminal device transmits the first request message to the network device, the network device may also transmit a reject message. A new RRC message such as RRCLowerPowerReject may be introduced. In this case, the terminal device continues to use a main-receiver monitoring state.

Optionally, after establishment of RRC connection, the terminal device in the RRC idle state or in the RRC inactive state may transmit the first request message to the network device.

In the above method, by means of introducing a request message from the terminal device, the terminal device in the RRC idle state or in the RRC inactive state in need of energy saving can transmit a request to a network, so as to assist the network in determining that the terminal device is to enter the ultra-lower power receiver state. Finally, energy saving at the terminal device can be achieved, and the problem of when the terminal device enters the ultra-lower power receiver state can be solved.

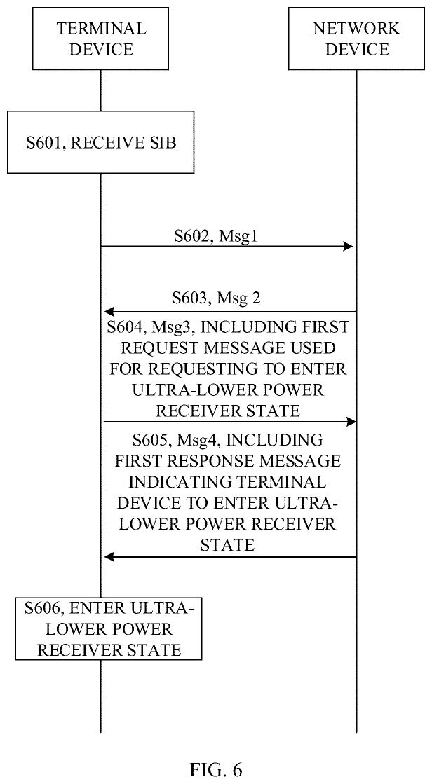

Reference is made to FIG. 6, where FIG. 6 is a schematic diagram of another method for requesting a monitoring state provided in embodiments of the disclosure. As illustrated in FIG. 6, the method for requesting the monitoring state includes the following.

S601, a terminal device receives an SIB.

S602, the terminal device transmits Msg1 to a network device.

S603, the network device transmits Msg2 to the terminal device.

S604, the terminal device transmits Msg3 to the network device. The Msg3 includes a first request message, and the first request message is used for requesting to enter an ultra-lower power receiver state.

S605, the network device transmits Msg4 to the terminal device. The Msg4 includes a first response message, and the first response message indicates the terminal device to enter the ultra-lower power receiver state.

S606, the terminal device enters the ultra-lower power receiver state.

The method for requesting the monitoring state provided in embodiments of the disclosure has been described above, and a communication apparatus provided in embodiments of the disclosure will be described below.

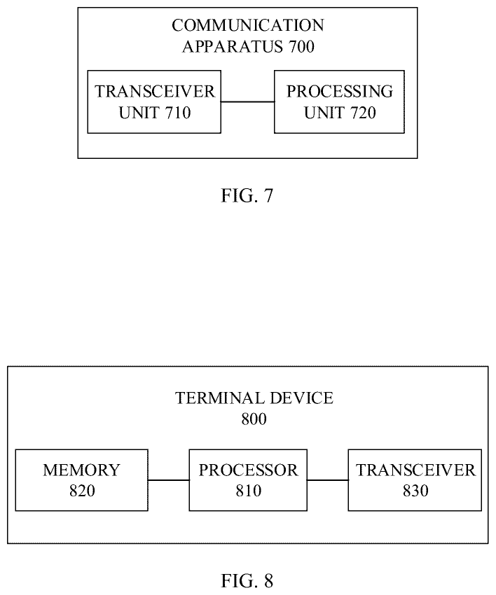

Reference is made to FIG. 7, where FIG. 7 is a schematic diagram of a communication apparatus provided in embodiments of the disclosure. The communication apparatus 700 is applicable to a terminal device and includes a transceiver unit 710. The communication apparatus 700 may be a terminal device, or a chip or an integrated circuit in the terminal device.

The transceiver unit 710 is configured to transmit a first request message to a network device and receive a first response message from the network device. The first request message is used for requesting to enter an ultra-lower power receiver state. The first response message indicates the terminal device to enter the ultra-lower power receiver state.

In embodiments of the disclosure, the terminal device transmits the first request message to the network device to request to enter the ultra-lower power receiver state. If the terminal device receives the first response message from the network device and the first response message indicates the terminal device to enter the ultra-lower power receiver state, the terminal device enters the ultra-lower power receiver state. In this way, by means of introducing a request message from the terminal device, the terminal device in need of energy saving can transmit a request to a network, so as to assist the network in determining that the terminal device is to enter the ultra-lower power receiver state. Finally, energy saving at the terminal device can be achieved, and the problem of when the terminal device enters the ultra-lower power receiver state can be solved.

Optionally, as an embodiment, the terminal device is in an RRC connected state, and the transceiver unit 710 is further configured to receive configuration information from the network device. The configuration information indicates that the network device supports an LP-WUS and/or configures the terminal device to transmit the first request message to the network device.

Optionally, as an embodiment, the first request message contains assistance information.

Optionally, as an embodiment, the first request message further indicates a duration T1 for which the terminal device requests to enter the ultra-lower power receiver state.

Optionally, as an embodiment, the first response message further indicates a duration T2 for which the terminal device enters the ultra-lower power receiver state.

Optionally, as an embodiment, the apparatus further includes a processing unit 720. The processing unit 720 is configured to: turn off a main receiver and enter the ultra-lower power receiver state; and turn on the main receiver and exit the ultra-lower power receiver state, upon elapse of the duration T2 for entering the ultra-lower power receiver state.

Optionally, as an embodiment, the processing unit 720 is configured to: turn off a main receiver and enter the ultra-lower power receiver state; and turn on the main receiver and exit the ultra-lower power receiver state, when receiving the LP-WUS from the network device or transmitting uplink data.

Optionally, as an embodiment, the terminal device is in an RRC idle state or in an RRC inactive state, and the transceiver unit 710 is further configured to receive an SIB. The SIB indicates that the network device supports an LP-WUS and/or the network device allows the terminal device to transmit the first request message.

Optionally, as an embodiment, the first request message is transmitted in Msg3, MsgA, or a CG.

Optionally, as an embodiment, when the first request message is transmitted in the Msg3, the first response message is received in Msg4. When the first request message is transmitted in the MsgA, the first response message is received in MsgB.

Optionally, as an embodiment, the processing unit 720 is configured to turn off a main receiver and enter the ultra-lower power receiver state.

Optionally, as an embodiment, the first request message is transmitted through an MAC CE or an RRC dedicated signaling.

It may be understood that, the transceiver unit 710 in embodiments of the disclosure may be implemented by a transceiver or a transceiver-related assembly, and the processing unit 720 may be implemented by a processor or a processor-related assembly.

Reference is made to FIG. 8, where FIG. 8 is a schematic diagram of a terminal device provided in embodiments of the disclosure. The terminal device 800 includes a processor 810, a memory 820, and a transceiver 830. The memory 820 is configured to store instructions or programs. The processor 810 is configured to execute the instructions or programs stored in the memory 820. The instructions or programs stored in the memory 820, when executed, are operable with the processor 810 to implement operations executed by the processing unit 720 in the foregoing embodiments, and are operable with the transceiver 830 to implement operations executed by the transceiver unit 710 in the foregoing embodiments.

It may be understood that, the communication apparatus 700 in embodiments of the disclosure may correspond to the terminal device in the method for requesting the monitoring state in embodiments of the disclosure, and operations and/or functions of units in the communication apparatus 700 or the terminal device 800 are respectively intended for implementing corresponding operations in the above method for requesting the monitoring state, which will not be repeated herein for the sake of brevity.

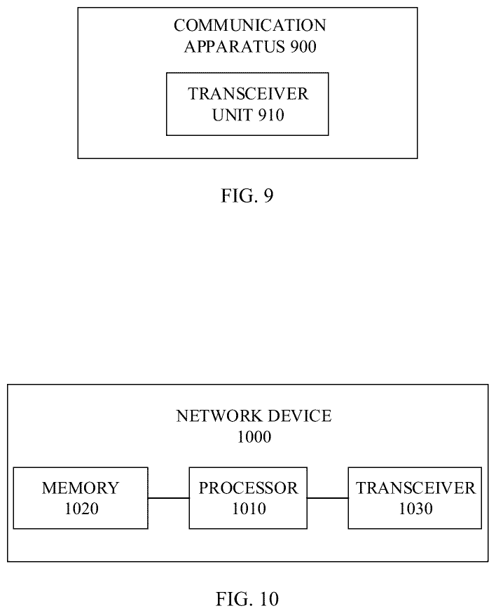

Reference is made to FIG. 9, where FIG. 9 is a schematic diagram of another communication apparatus provided in embodiments of the disclosure. The communication apparatus 900 is applicable to a network device and includes a transceiver unit 910. The communication apparatus 900 may be a network device, or a chip or an integrated circuit in the network device.

The transceiver unit 910 is configured to receive a first request message from a terminal device and transmit a first response message to the terminal device. The first request message is used for requesting to enter an ultra-lower power receiver state. The first response message indicates the terminal device to enter the ultra-lower power receiver state.

In embodiments of the disclosure, the network device receives from the terminal device the first request message by which the terminal device requests to enter the ultra-lower power receiver state. If the network device transmits the first response message to the terminal device and the first response message indicates the terminal device to enter the ultra-lower power receiver state, the terminal device enters the ultra-lower power receiver state. In this way, by means of introducing a request message from the terminal device, the terminal device in need of energy saving can transmit a request to a network, so as to assist the network in determining that the terminal device is to enter the ultra-lower power receiver state. Finally, energy saving at the terminal device can be achieved, and the problem of when the terminal device enters the ultra-lower power receiver state can be solved.

Optionally, as an embodiment, the terminal device is in an RRC connected state, and the transceiver unit 910 is further configured to transmit configuration information to the terminal device. The configuration information indicates that the network device supports an LP-WUS and/or configures the terminal device to transmit the first request message to the network device.

Optionally, as an embodiment, the first request message contains assistance information.

Optionally, as an embodiment, the first request message further indicates a duration T1 for which the terminal device requests to enter the ultra-lower power receiver state.

Optionally, as an embodiment, the first response message further indicates a duration T2 for which the terminal device enters the ultra-lower power receiver state.

Optionally, as an embodiment, the terminal device is in an RRC idle state or in an RRC inactive state, and the transceiver unit 910 is further configured to transmit an SIB. The SIB indicates that the network device supports an LP-WUS and/or the network device allows the terminal device to transmit the first request message.

Optionally, as an embodiment, the first request message is transmitted in Msg3, MsgA, or a CG.

Optionally, as an embodiment, when the first request message is transmitted in the Msg3, the first response message is received in Msg4. When the first request message is transmitted in the MsgA, the first response message is received in MsgB.

Optionally, as an embodiment, the first request message is transmitted through an MAC CE or an RRC dedicated signaling.

It may be understood that, the transceiver unit 910 in embodiments of the disclosure may be implemented by a transceiver or a transceiver-related assembly.

Reference is made to FIG. 10, where FIG. 10 is a schematic diagram of a network device provided in embodiments of the disclosure. The network device 1000 includes a processor 1010, a memory 1020, and a transceiver 1030. The memory 1020 is configured to store instructions or programs. The processor 1010 is configured to execute the instructions or programs stored in the memory 1020. The instructions or programs stored in the memory 1020, when executed, are operable with the transceiver 1030 to implement operations executed by the transceiver unit 910 in the foregoing embodiments.

It may be understood that, the communication apparatus 900 in embodiments of the disclosure may correspond to the network device in the method for requesting the monitoring state in embodiments of the disclosure, and operations and/or functions of units in the communication apparatus 900 or the network device 1000 are respectively intended for implementing corresponding operations in the above method for requesting the monitoring state, which will not be repeated herein for the sake of brevity.

A computer-readable storage medium is further provided in embodiments of the disclosure. The computer-readable storage medium is configured to store instructions which, when executed by a processor, are operable to implement operations related to the terminal device in the foregoing method embodiments.

A computer-readable storage medium is further provided in embodiments of the disclosure. The computer-readable storage medium is configured to store instructions which, when executed by a processor, are operable to implement operations related to the network device in the foregoing method embodiments.

A computer program product is further provided in embodiments of the disclosure. The computer program product includes instructions which, when executed by a computer or a processor, are operable with the computer or the processor to implement one or more steps in the foregoing method embodiments. If various modules of the devices described above are implemented as software functional units and sold or used as standalone products, they may be stored in a computer-readable storage medium.

It may be noted that, the memory described in the disclosure is intended to include, but is not limited to, these and any other suitable types of memory.

It may be understood that, in various embodiments of the disclosure, the magnitude of a sequence number of each of the foregoing processes does not imply an execution order, and the execution order between the processes may be determined according to function and internal logic thereof, which shall not constitute any limitation to the implementation of embodiments of the disclosure.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple network units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, a read-only memory (ROM), a random access memory (RAM), a magnetic disk, or an optical disk.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

What is claimed is:

1. A method for requesting a monitoring state, applicable to a terminal device and comprising:
transmitting a first request message to a network device, wherein the first request message is used for requesting to enter an ultra-lower power receiver state; and
receiving a first response message from the network device, wherein the first response message indicates the terminal device to enter the ultra-lower power receiver state.

2. The method of claim 1, wherein the terminal device is in a radio resource control (RRC) connected state, and before transmitting the first request message to the network device, the method further comprises:
receiving configuration information from the network device, wherein the configuration information indicates that the network device supports an ultra-lower power wake-up signal (LP-WUS) and/or configures the terminal device to transmit the first request message to the network device.

3. The method of claim 2, wherein the first request message contains assistance information.

4. The method of claim 2, wherein the first request message further indicates a duration T1 for which the terminal device requests to enter the ultra-lower power receiver state.

5. The method of claim 2, wherein the first response message further indicates a duration T2 for which the terminal device enters the ultra-lower power receiver state.

6. The method of claim 5, wherein after receiving the first response message from the network device, the method further comprises:
turning off a main receiver and entering the ultra-lower power receiver state; and
turning on the main receiver and exiting the ultra-lower power receiver state, upon elapse of the duration T2 for entering the ultra-lower power receiver state.

7. The method of claim 2, wherein after receiving the first response message from the network device, the method further comprises:
turning off a main receiver and entering the ultra-lower power receiver state; and
turning on the main receiver and exiting the ultra-lower power receiver state, when receiving the LP-WUS from the network device or transmitting uplink data.

8. A terminal device, comprising:
a transceiver;
a memory configured to store computer programs; and
a processor configured to execute the computer programs stored in the memory to cause the transceiver to:
transmit a first request message to a network device, wherein the first request message is used for requesting to enter an ultra-lower power receiver state; and
receive a first response message from the network device, wherein the first response message indicates the terminal device to enter the ultra-lower power receiver state.

9. The terminal device of claim 8, wherein the terminal device is in a radio resource control (RRC) connected state, and the processor is further configured to cause the transceiver to:
receive configuration information from the network device, wherein the configuration information indicates that the network device supports an ultra-lower power wake-up signal (LP-WUS) and/or configures the terminal device to transmit the first request message to the network device.

10. The terminal device of claim 9, wherein the first request message contains assistance information.

11. The terminal device of claim 9, wherein the first request message further indicates a duration T1 for which the terminal device requests to enter the ultra-lower power receiver state.

12. The terminal device of claim 9, wherein the first response message further indicates a duration T2 for which the terminal device enters the ultra-lower power receiver state.

13. The terminal device of claim 12, wherein the processor is configured to:
turn off a main receiver and enter the ultra-lower power receiver state; and
turn on the main receiver and exit the ultra-lower power receiver state, upon elapse of the duration T2 for entering the ultra-lower power receiver state.

14. A network device, comprising:
a transceiver;
a memory configured to store computer programs; and
a processor configured to execute the computer programs stored in the memory to cause the transceiver to:
receive a first request message from a terminal device, wherein the first request message is used for requesting to enter an ultra-lower power receiver state; and
transmit a first response message to the terminal device, wherein the first response message indicates the terminal device to enter the ultra-lower power receiver state.

15. The network device of claim 14, wherein the terminal device is in a radio resource control (RRC) connected state, and the processor is further configured to cause the transceiver to:
transmit configuration information to the terminal device, wherein the configuration information indicates that the network device supports an ultra-lower power wake-up signal (LP-WUS) and/or configures the terminal device to transmit the first request message to the network device.

16. The network device of claim 15, wherein the first request message contains assistance information.

17. The network device of claim 15, wherein the first request message further indicates a duration T1 for which the terminal device requests to enter the ultra-lower power receiver state.

18. The network device of claim 15, wherein the first response message further indicates a duration T2 for which the terminal device enters the ultra-lower power receiver state.

19. The network device of claim 14, wherein the terminal device is in an RRC idle state or in an RRC inactive state, and the processor is further configured to cause the transceiver to:
transmit a system information broadcast (SIB), wherein the SIB indicates that the network device supports an LP-WUS and/or the network device allows the terminal device to transmit the first request message.

20. The network device of claim 19, wherein the first request message is transmitted in message 3 (Msg3), message A (MsgA), or a configured grant (CG).
